(19) United States
(12) Patent Application Publication
(10) Pub. No.: US 2012/0077398 A1
(43) Pub. Date: Mar. 29, 2012

(54) FIBROUS SUBSTRATE, MANUFACTURING PROCESS AND USES OF SUCH A FIBROUS SUBSTRATE

(75) Inventors: Patrice Gaillard, Hagetaubin (FR); Alexander Korzhenko, Pau (FR)

(73) Assignee: ARKEMA FRANCE, COLOMBES (FR)

(21) Appl. No.: 13/319,557

(22) PCT Filed: May 7, 2010
(86) PCT No.: PCT/FR10/50892

§ 371 Date: Dec. 16, 2011

Related U.S. Application Data
(60) Provisional application No. 61/235,475, filed on Aug. 20, 2009.

(30) Foreign Application Priority Data
May 12, 2009 (FR) 0953135
Dec. 31, 2009 (FR) 0959684

(51) Int. Cl. B32B 5/02; H05B 6/64; B82Y 40/00

(52) U.S. Cl. 442/59; 264/460; 977/961

(57) ABSTRACT

The invention relates to a fibrous substrate such as woven fabrics, felts, nonwoven fabrics that may be in the form of strips, laps or braids, said substrate being impregnated with an organic polymer or blend of organic polymers containing carbon nanotubes (CNTs). Another subject of the invention is a process for manufacturing said substrate, and the various uses thereof for the manufacture of 3D mechanical components.

The invention relates to a fibrous substrate, to a manufacturing process and to the uses of such a fibrous substrate.

The term “fibrous substrate” means fabrics, felts or nonwovens that may be in the form of strips, laps, braids, locks or pieces.

A fibrous substrate comprises an assembly of one or more fibres. When the fibres are continuous, their assembly forms fabrics. When the fibres are short, their assembly forms a substrate of felt or nonwoven type.

The fibres that can make up a fibrous substrate may be carbon fibres, glass fibres, polymer-based fibres or plant fibres, alone or as a mixture.

Among the polymer-based fibres, mention may be made of organic polymer fibres such as thermoplastic polymer fibres or thermosetting polymer fibres.

The present invention focuses on light composite materials for manufacturing mechanical components having a structure that may be three-dimensional and having good mechanical strength and heat resistance properties and being capable of dissipating electrostatic charges, i.e. properties that are compatible with the manufacture of components in the mechanical, aeronautical and nautical fields.

It is known practice to use refractory fabrics preimpregnated with a resin to make a heat-insulating matrix in order to ensure the thermal protection of mechanical devices subjected to high temperatures, as may be the case in the aeronautical or motor vehicle field. Reference may be made to European patent No. 0 398 787, which describes a heat-protective layer comprising a refractory fabric, for protecting the shroud of a ramjet engine combustion chamber. Besides the complexity involved in producing this heat-protective layer, the refractory fabric buried in this layer fulfils only the heat-shield function.

Use has also been made in recent years of composite fibres for manufacturing, in particular, various aeronautical or motor vehicle components. These composite fibres, which are characterized by good thermomechanical strength and chemical resistance, are formed from a filamentous reinforcer that forms armouring, for distributing the tensile strength, flexural strength or compression strength work, for giving the material chemical protection in certain cases and for giving it its shape.

Reference may be made, for example, to patent application FR 07/04620 published under No. 2 918 081 on 2 Jan. 2009, which describes a process for impregnating continuous fibres with a composite polymer matrix containing a thermoplastic polymer.

The processes for manufacturing composite components from these coated fibres include various techniques, for instance contact moulding, spray moulding, autoclave drape moulding or low-pressure moulding.

One technique for producing hollow components is that known as filament winding, which consists in impregnating dry fibres with a resin and then in winding them on a mandrel formed from armouring and having a shape adapted to the component to be manufactured. The component obtained by winding is then heat-cured. Another technique, for making plates or hulls, consists in impregnating fibre fabrics and then pressing them in a mould in order to consolidate the stratified composite obtained.

Research has been conducted in order to optimize the composition of the impregnation resin so that it is liquid enough to impregnate fibres, without, however, leading to running when the fibres are removed from the bath.

An impregnation composition has thus been proposed, containing a thermosetting resin (such as an epoxide resin, for example bisphenol A diglycidyl ether, associated with a hardener) combined with a particular rheology regulator, which is miscible with the said resin, such that the composition has Newtonian behaviour at high temperature (40 to 150° C.). The rheology regulator is preferably a block polymer comprising at least one block that is compatible with the resin, such as a methyl methacrylate homopolymer or a copolymer of methyl methacrylate with, in particular, dimethylacrylamide, a block that is incompatible with the resin, formed, for example, from 1,4-butadiene or n-butyl acrylate monomers, and optionally a polystyrene block. As a variant, the rheology regulator may comprise two blocks that are incompatible with each other and with the resin, such as a polystyrene block and a poly-1,4-butadiene block.

Although this solution effectively makes it possible to overcome the drawbacks of the prior art on account of the Newtonian nature of the composition and of its viscosity suited to coating at high temperature, and also on account of its pseudoplastic nature at low temperature, it is limited to the production of composites based on thermosetting resin.

Another solution using a thermoplastic coating composition consists in coating fibres with a polyether ether ketone (PEEK), with poly(phenylene sulfide) (PPS) or with polyphenyl sulfone (PPSU), for example.

The technique described in this patent application makes it possible to obtain continuous fibres impregnated with a composite polymer matrix, i.e. fibres coated with a thermoplastic polymer containing CNTs. These impregnated fibres may be used directly or in the form of fabric formed from a two-directional network of impregnated fibres. The fibres may be used for the manufacture of fabrics included in the composition of composite plates.

No solution at the present time proposes a material other than materials manufactured from preimpregnated fibres optionally woven after impregnation as an alternative to metal for the production of structural components of motors, in particular mobile ones, with a view to lightening them while at the same time giving them mechanical strength comparable to that achieved with structural components made of metal and/or to ensuring thermal protection and/or to ensuring the evacuation of electrostatic charges.

Now, the need has been felt to have a light material that offers mechanical strength comparable to that of metal, affording an increase in the electrical and/or heat resistance of the mechanical components produced in order to ensure the evacuation of heat and/or of electrostatic charge, for the simple production of any 3-D mechanical structure especially for the motor vehicle, aeronautical or nautical field.

Reference may be made to the prior are represented by document FR 2 562 467. This document describes the manufacture of a composite material by covering a lock of fibres, in particular glass fibre, impregnated at the core with a fine powder of polyamide 6, with a flexible sheath of polyamide 12; this covering is performed by extrusion and then drying in ambient air. However the said document does not envisage the addition of conductive powder such as a powder of carbon nanotubes in order to improve the mechanical and/or thermal and/or electrical properties of a mechanical component based on this composite material.

Reference may also be made to the prior art constituted by document WO 2007/044 889. This document describes a friction composite material comprising a mat of needled nonwoven fibres, a resin matrix and carbon nanotubes introduced in very small amounts to improve the friction properties of the material. This material is intended for applications in which the parts are friction parts, for instance brake pads or clutch plates. CNTs roughly represent between 0.004 and 0.08 part of the volume of the friction composite material thus made. No information regarding the weight content of CNT relative to the weight of the polymer is described or suggested. It is a mat of needled nonwoven fibres, i.e. a nonwoven obtained via a specific technique adapted to the manufacture of friction parts, impregnated with a resin and into which is introduced CNTs, with no information regarding the content relative to the polymer.

Reference may also be made to the prior art constituted by document WO 2009/007 617, which is considered as being the closest prior art. This document describes a process for impregnating continuous fibres with a composite polymer matrix containing a thermoplastic polymer and carbon nanotubes. The process concerns the impregnation of continuous fibres. The fibres are in the form of one-directional yarns or, after a spinning step, in the form of a fabric formed from a two-directional network of fibres.

The said document does not describe and does not suggest a process for manufacturing a fibrous substrate comprising an assembly of one or more continuous fibres such as fabrics, or an assembly of short fibres such as felts and nonwovens, which may be in the form of strips, laps, braids, locks or pieces, preimpregnated with an organic polymer or a mixture of organic polymers containing carbon nanotubes (CNT), making it possible to have a better dispersion/distribution of the CNTs within the substrate, leading to better homogeneity of the physicochemical properties, and consequently to better overall properties of the final product.

The said document does not describe a fibrous substrate constituting felts or nonwovens, impregnated with an organic polymer or mixture of polymers containing carbon nanotubes in which the carbon nanotubes represent from 0.1% to 30% and preferably from 0.3% to 15% of the weight of the organic polymer or of the mixture.

The Applicant has sought to produce a material that can, preferably, be both light and mechanically strong, serve as a heat shield, which is sought especially during the entry of aircraft into the atmosphere, and that is adapted for the evacuation of electrostatic charges, with a simple manufacturing process.

The solution proposed by the present invention satisfies all these criteria and is easy to use in the manufacture of components having a three-dimensional structure such as, in particular, aeroplane wings, an aeroplane fuselage, a boat hull, motor vehicle side rails or spoilers, or alternatively brake discs or the body of a plunger cylinder or of a steering wheel.

To this end, the invention proposes a process for manufacturing a fibrous substrate in which the fibrous substrate comprises an assembly of one or more continuous fibres such as fabrics, or an assembly of short fibres such as felts and nonwovens that may be in the form of strips, laps, braids, locks or pieces, mainly characterized in that it comprises:
impregnation of the said fibrous substrate with an organic polymer or a mixture of organic polymers containing carbon nanotubes (CNTs), and then:
heating the said impregnated fibrous substrate up to the softening point of the polymer, the heating being performed by microwave irradiation or by induction.

It has been observed, surprisingly, that heating by microwave irradiation or induction is particularly suited in the presence of conductive fillers in the substrate such as carbon nanotubes in the preimpregnated substrate, since a better dispersion/distribution of the CNTs within the substrate is then obtained, leading to better homogeneity of the physicochemical properties, and consequently to better overall properties of the final product.

The invention also relates to a fibrous substrate comprising an assembly of one or more continuous fibres such as fabrics, or an assembly of short fibres such as felts, nonwovens that may be in the form of strips, laps, braids or locks, preimpregnated with an organic polymer or a mixture of organic polymers containing carbon nanotubes (CNTs) obtained via the process of the invention.

The process according to the invention is particularly suited to the preparation of substrates formed from short fibres.

Thus, the invention also relates to fibrous substrates comprising an assembly of one or more fibres constituting felts or nonwovens that may be in the form of strips, laps, braids, locks or pieces, preimpregnated with an organic polymer or a mixture of organic polymers containing carbon nanotubes (CNTs), in which the carbon nanotubes represent from 0.1% to 30% and preferably from 0.3% to 15% of the weight of the organic polymer or of the mixture of organic polymers.

The impregnation of the fibrous substrate may be carried out by placing this fibrous substrate in a bath of fluid organic polymer containing carbon nanotubes. For the purpose of the invention, the term “fluid” means a medium that flows under its own weight and that has no intrinsic shape (unlike a solid), for instance a liquid that may be more or less viscous or a powder suspended in a gas (for example air) generally known as a “fluidized bed”.

The term “organic polymer” means thermoplastic polymers and thermosetting polymers.

The fibrous substrates according to the invention are particularly suited for making two- or three-dimensional parts, preferably for making three-dimensional parts.

The use of fibrous substrates for making three-dimensional parts may involve, for example, the following steps:
the fibrous substrates are preimpregnated with a composition containing an organic polymer (thermoplastic or thermosetting) or a mixture of organic polymers and CNTs,
these fibrous substrates preimpregnated with polymer and with CNTs are arranged on a preform, in zigzag and such that they at least partly superpose until the desired thickness is obtained,
the assembly is heated up to the softening point of the polymer,
the preform is removed after cooling.

The fibrous substrates may be arranged, for example, by means of a robot.

As a variant, the fibrous substrates according to the invention may be used for the manufacture of three-dimensional parts, for example by using one of the following known techniques:
low-pressure injection (resin transfer moulding, RTM),
the pultrusion technique, or
the pull-winding technique.

The invention also relates to the use of a fibrous substrate as described for the manufacture of 3-D mechanical components, especially aeroplane wings, an aeroplane fuselage, a boat hull, motor vehicle side rails or spoilers, or alternatively brake discs or the body of a plunger cylinder or of a steering wheel.

Other particular features and advantages of the invention will emerge clearly on reading the description provided hereinbelow, which is given as a non-limiting illustration.

The fibres constituting the fibrous substrates may be carbon fibres, glass fibres, polymer-based fibres or plant fibres, alone or as a mixture, for instance:
synthetic polymer fibres based especially on:
(i) poly(vinyl alcohol),
(ii) polyamide such as polyamide 6 (PA-6), polyamide 11 (PA-11), polyamide 12 (PA-12), polyamide 6/6 (PA-6/6), polyamide 4/6 (PA-4/6), polyamide 6/10 (PA-6/10), polyamide 6/12 (PA-6/12), aromatic polyamides, in particular polyphthalamides and aramid, and block copolymers, especially polyamide/polyether,
(iii) polyolefins such as high-density polyethylene, polypropylene and copolymers of ethylene and/or of propylene,
(iv) polyester such as polyhydroxyalkanoates,
(v) polyaryl ether ketone (PAEK) such as polyether ether ketone (PEEK) and polyether ketone ketone (PEKK),
(vi) fluoro polymer, chosen especially from:
(a) those comprising at least 50 mol % of at least one fluoro monomer of formula (I):

CFX₁═CX₂X₃ (I)

in which X₁, X₂ and X₃ independently denote a hydrogen or halogen atom (in particular a fluorine or chlorine atom), such as poly(vinylidene fluoride) (PVDF), preferably in α form, poly(trifluoroethylene) (PVF3), polytetrafluoroethylene (PTFE), copolymers of vinylidene fluoride with either hexafluoropropylene (HFP), or trifluoroethylene (VF3), or tetrafluoroethylene (TFE), or chlorotrifluoroethylene (CTFE), fluoroethylene/propylene (FEP) copolymers, copolymers of ethylene with either fluoroethylene/propylene (FEP), or tetrafluoroethylene (TFE), or chlorotrifluoroethylene (CTFE);
(b) those comprising at least 50 mol % of at least one monomer of formula (II):

R—O—CH═CH₂ (II)

in which R denotes a perhalogenated (in particular perfluoro) alkyl radical, such as perfluoropropyl vinyl ether (PPVE), perfluoroethyl vinyl ether (PEVE) and copolymers of ethylene with perfluoromethyl vinyl ether (PMVE),
(vii) thermoplastic polyurethane (TPU);
(viii) polyethylene or polybutylene terephthalates;
(ix) polyvinyl chloride;
(x) phenoxy polymers (or resins);
(xi) unsaturated polyesters, epoxy resins, vinyl esters, phenolic resins, polyurethanes, cyanoacrylates and polyimides, such as bis-maleimide resins, aminoplasts (resulting from the reaction of an amine such as melamine with an aldehyde such as glyoxal or formaldehyde), and mixtures thereof;
carbon fibres;
glass fibres, especially of E, R or S2 type;
boron fibres;
silica fibres;
natural fibres such as flax, hemp, sisal or silk; and
mixtures thereof, such as mixtures of glass, carbon and aramid fibres.

According to the invention, the term “carbon nanotubes” means hollow particles (unlike nanofibres, which are solid particles) of elongated shape, with a length/diameter ratio of greater than 1 and more especially greater than 10, and whose diameter is less than one micron. These nanotubes comprise one or more cylindrical walls arranged coaxially along the axis of the largest dimension.

The carbon nanotubes that may be used according to the invention may be of the single-wall, double-wall or multi-wall type, formed from graphite leaflets. Double-wall nanotubes may especially be prepared as described by Flahaut et al. in Chem. Commun. (2003), 1442. Multi-wall nanotubes may, for their part, be prepared as described in document WO 03/02456.

The carbon nanotubes usually have a mean diameter ranging from 0.1 to 200 nm, preferably from 0.1 to 100 nm, more preferentially from 0.4 to 50 nm and better still from 1 to 30 nm, and advantageously a length of 0.1 to 10 μm. Their length/diameter ratio is preferably greater than 10 and usually greater than 100. Their specific surface area is, for example, between 100 and 300 m²/g and their apparent density may especially be between 0.05 and 0.5 g/cm³ and more preferentially between 0.1 and 0.2 g/cm³. Multi-wall nanotubes may comprise, for example, from 5 to 15 walls and more preferentially from 7 to 10 walls.

These carbon nanotubes may be crude or surface-treated especially to make them hydrophilic. Thus, these nanotubes may be purified and/or treated (for example oxidized) and/or ground and/or functionalized, before being used in the process according to the invention.

An example of crude carbon nanotubes is especially commercially available from the company Arkema under the trade name Graphistrength® C100.

The organic polymer or the mixture of organic polymers is chosen from thermoplastic polymers and thermosetting polymers.

The mixture. i.e. the thermoplastic polymer. composition or the thermoplastic polymer is chosen from:
polyamides such as polyamide 6 (PA-6), polyamide 11 (PA-11), polyamide 12 (PA-12), polyamide 6/6 (PA-6/6), polyamide 4/6 (PA-4/6), polyamide 6/10 (PA-6/10) and polyamide 6/12 (PA-6/12), and also copolymers, especially block copolymers, containing amide monomers and other monomers such as polytetramethylene glycol (PTMG);
aromatic polyamides such as polyphthalamides;
fluoro polymers chosen from:
(i) those comprising at least 50 mol % of at least one fluoro monomer and preferably formed from monomers of formula (I):

CFX₁=CX₂X₃ (I)

in which X₁, X₂ and X₃ independently denote a hydrogen or halogen atom (in particular a fluorine or chlorine atom), such as:
poly(vinylidene fluoride) (PVDF), preferably in α form,
poly(trifluoroethylene) (PVF3),
polytetrafluoroethylene (PTFE), copolymers of vinylidene fluoride with either hexafluoropropylene (HFP), or
trifluoroethylene (VF3), or
tetrafluoroethylene (TFE), or
chlorotrifluoroethylene (CTFE), fluoroethylene/propylene (FEP) copolymers, copolymers of ethylene with either
fluoroethylene/propylene (FEP), or tetrafluoroethylene (TFE), or
chlorotrifluoroethylene (CTFE);
(ii) those comprising at least 50 mol % of at least one monomer and preferably formed from monomers of formula (II):

R—O—CH═CH₂ (II)

in which R denotes a perhalogenated (in particular perfluoro) alkyl radical, such as
perfluoropropyl vinyl ether (PPVE),
perfluoroethyl vinyl ether (PEVE) and copolymers of ethylene with perfluoromethyl vinyl ether (PMVE),
polyaryl ether ketones (PAEK) such as polyether ether ketone (PEEK) and polyether ketone ketone (PEKK);
polyetherimides (PEI);
polyphenylene sulfides (PPS);
polyolefins such as polyethylene (PE), polypropylene (PP) and copolymers of ethylene and propylene (PE/PP), optionally functionalized with an acid or anhydride group;
thermoplastic polyurethanes (TPU);
polyethylene or polybutylene terephthalates;
polyvinyl chlorides;
polyalkyl (meth)acrylates with alkyl in C1 to C8, for instance methyl, ethyl, butyl or 2-ethylhexyl (meth)acrylate;
poly(meth)acrylic acids;
polycarbonates;
silicone polymers;
phenoxy polymers (or resins); and mixtures or copolymers thereof.

Preferably, the thermoplastic polymer is chosen from fluoro polymers or copolymers containing at least 50% of VDF, polyamides or copolyamides, polyaryl ethers such as PEKK or polyvinyl alcohols and PVCs or PEI or PPS.

The mixture, i.e. the thermosetting polymer composition or the thermosetting polymer, is chosen from:
unsaturated polyesters, epoxy resins, vinyl esters, phenolic resins, polyurethanes, cyanoacrylates and polyimides, such as bis-maleimide resins, aminoplasts (resulting from the reaction of an amine such as melamine with an aldehyde such as glyoxal or formaldehyde), and mixtures thereof.

The term “thermosetting polymers” or “thermosetting resins” means a material that is generally liquid at room temperature, or which has a low melting point, and which is capable of being hardened, generally in the presence of a hardener, under the effect of heat, a catalyst, or a combination of the two, to obtain a thermoset resin. This resin is formed from a material containing polymer chains of variable length linked together via covalent bonds, so as to form a three-dimensional network. As regards its properties, this thermoset resin is unmeltable and insoluble. It can be softened by heating it above its glass transition temperature (Tg), but once it has been given a shape, it cannot be subsequently reshaped by heating.

The thermosetting polymers (or resins) included in the constitution of the thermosetting fibres according to the invention are chosen from: unsaturated polyesters, epoxy resins, vinyl esters, phenolic resins, polyurethanes, cyanoacrylates and polyimides, such as bis-maleimide resins, aminoplasts (resulting from the reaction of an amine such as melamine with an aldehyde such as glyoxal or formaldehyde), and mixtures thereof.

The unsaturated polyesters resulting from the polymerization by condensation of dicarboxylic acids containing an unsaturated compound (such as maleic anhydride or fumaric acid) and of glycols such as propylene glycol. They are generally hardened by dilution in a reactive monomer, such as styrene, followed by reacting the latter with the unsaturations present on these polyesters, generally with the aid of peroxides or a catalyst, in the presence of heavy metal salts or an amine, or alternatively with the aid of a photoinitiator, ionizing radiation, or a combination of these various techniques.

The vinyl esters comprise the products of reaction of the epoxides with (meth)acrylic acid. They may be hardened after the dissolution in styrene (in a similar manner to the polyester resins) or with the aid of organic peroxides.

The epoxy resins are formed from materials containing one or more oxirane groups, for example from 2 to 4 oxirane functions per molecule. When they are polyfunctional, these resins may be formed from linear polymers bearing epoxy end groups, or whose backbone comprises epoxy groups, or alternatively whose backbone bears epoxy side groups. They generally require an acid anhydride or an amine as hardener.

These epoxy resins may result from the reaction of epichlorohydrin with a bisphenol such as bisphenol A. As a variant, they may be alkyl and/or alkenyl glycidyl ethers or esters; optionally substituted polyglycidyl ethers of mono- and polyphenols, especially bisphenol A polyglycidyl ethers; polyglycidyl ethers of polyols; polyglycidyl ethers of aliphatic or aromatic polycarboxylic acids; polyglycidyl esters of polycarboxylic acids; novolac polyglycidyl ethers. Also as a variant, they may be products of reaction of epichlorohydrin with aromatic amines or glycidyl derivatives of aromatic mono- or diamines. Cycloaliphatic epoxides and preferably diglycidyl ethers of bisphenol A (or BADGE), F or A/F may also be used in the present invention.

Among the hardeners or crosslinking agents, use may be made of products of functional diamine or triamine type used in contents ranging from 1% to 5%.

According to the invention, preimpregnated fibrous substrates are used for the manufacture of mechanical components of 2-D or 3-D structure.

### ACCORDING TO A FIRST EXEMPLARY EMBODIMENT OF A USE

the fibrous substrates are preimpregnated with a composition containing a (thermoplastic or thermosetting) organic polymer or a mixture of organic polymers and CNTs;
these fibrous substrates preimpregnated with polymer and with CNT are placed on a preform, in a staggered arrangement and so that they are at least partly superposed, until the desired thickness is obtained. The fibrous substrates are optionally preheated to a softening temperature of the polymer and are placed, for example, by means of a robot.

The heating may be performed by laser, which will also make it possible to adjust the positioning of the fibrous substrates relative to the perform.
the assembly is then left to cool to room temperature.
annealing may be envisaged, either by raising the temperature, or by irradiation, depending on the nature of the polymer. The preform is then removed.

### ACCORDING TO A SECOND EXAMPLE

The process uses the low-pressure injection technique (resin transfer moulding, RTM). To this end, the fibrous substrate is placed in a mould advantageously using the combination of polymers such as polyamides, phenoxy resins, or PEI, PPS, etc., including CNTs, followed by injection of thermosetting prepolymers such as epoxy resins, phenolic resins, polyester or vinyl ester, and heating according to the prior art; the polymer is injected with the CNTs and heating is performed. A polyamide, a phenoxy resin, or a PEI or PPS may advantageously be used as polymer.

### ACCORDING TO A THIRD EXAMPLE

The process uses the pultrusion technique. To this end, the fibrous substrate, which is in the form of unidirectional fibres or of strips of fabric, is passed through a bath of thermosetting resin and then through a heated die, where the forming and crosslinking (hardening) take place.

### ACCORDING TO A FOURTH EXAMPLE

The process uses the pull-winding technique. To this end, the fibrous substrate is continuously impregnated in a bath, and is then wound on a drum, for example, and the part is polymerized by placing it in an autoclave.

In each case, it is also possible to produce a deposit of organic polymer (thermoplastic or thermosetting polymer) comprising the CNTs on line before impregnation. The organic polymer then behaves like a thermoplastic polymer for the rheological characteristics.

Components having a two- or three-dimensional structure may thus be produced, for instance aeroplane wings, an aeroplane fuselage, a boat hull, motor vehicle side rails or spoilers, or alternatively brake discs or the body of a plunger cylinder or of a steering wheel.

In practice, the heating of the substrate may be performed by laser heating or with a plasma torch, a nitrogen torch or an infrared oven, or alternatively by microwave irradiation or by induction. According to the invention, this heating is advantageously performed by induction or microwave irradiation.

Specifically, the conductivity properties of the preimpregnated substrate are advantageous in combination with heating by induction or by microwave irradiation, since, in this case, the electrical conductivity is used and contributes towards obtaining curing to the core and better homogeneity of the fibrous substrate. The heat conduction of the fillers present in the preimpregnated fibrous substrate also contributes with this type of heating to curing to the core, improving the homogeneity of the substrate.

Heating by induction is obtained, for example, by exposing the substrate to an alternating electromagnetic field using a high-frequency unit of 650 kHz to 1 MHz.

Heating by microwave irradiation is obtained, for example, by exposing the substrate to an ultra-high-frequency electromagnetic field using an ultra-high-frequency generator of 2 to 3 GHz.

The step of impregnation of the fibrous substrates may be performed according to various techniques, depending especially on the physical form of the thermoplastic or thermosetting polymer or polymer mixture used: pulverulent or more or less liquid.

The impregnation of the fibrous substrates may take place in a bath of liquid polymer, containing the CNTs. When the fibrous substrates are in the form of a strip or lap, they may be circulated in the bath of fluid, for example liquid, polymer containing the CNTs. This liquid bath may contain the polymer or a mixture of polymers, alone or dispersed in an organic solvent or in water, for example in latex form.

The impregnation of the fibrous substrate may also be performed according to a process of impregnation in a fluidized bed, in which the polymer composition, i.e. the polymer or the mixture of polymers containing the CNTs, is in powder form. To do this, the substrates are introduced into impregnation baths as a fluidized bed of CNT-charged polymer particles, and these impregnated materials are optionally dried and may be heated, in order to perform the impregnation of the polymer on the fibres or fabrics, calendered if necessary. The pulverulent polymer and CNTs may be deposited on the fibrous fabrics as described in document FR 2 562 467 or EP 0 394 900.

It is also possible to deposit the mixture of powder of organic CNT and polymer directly onto the fibrous substrate, laid flat on a vibrating support, in order to enable distribution of the powder over the substrate.

As another variant, it is possible to extrude directly a flow of CNT-charged organic polymer onto the fibrous substrate that is in the form of a lap or strip or braid, and to perform calendering.

According to the invention, the nanotubes represent advantageously from 0.1% to 30% and preferably from 0.3% to 15% of the weight of the organic polymer or of the mixture of organic polymers.

1. Process for manufacturing a fibrous substrate comprising an assembly of one or more continuous fibres, or an assembly of short fibres in the form of strips, laps, braids, locks or pieces, characterized in that it comprises:
impregnating the assembly with an organic polymer containing carbon nanotubes or a mixture of organic polymers containing carbon nanotubes to form an impregnated fibrous substrate, and then:
heating said impregnated fibrous substrate to the softening point of the organic polymer or mixture of organic polymers, by microwave irradiation or by induction.

2. Process for manufacturing a fibrous substrate according to claim 1, characterized in that the heating by induction comprises exposing the impregnated fibrous substrate to an alternating electromagnetic fields using a high-frequency unit from 650 kHz to 1 MHz.

3. Process for manufacturing a fibrous substrate according to claim 1, characterized in that the heating by microwave irradiation comprises exposing the impregnated fibrous substrate to an ultra-high-frequency electromagnetic field using an ultra-high-frequency generator of 2 to 3 GHz.

4. Process for manufacturing a fibrous substrate according to claim 1, characterized in that the impregnaton is carried out by placing the assembly in a bath of fluid organic polymer containing carbon nanotubes CNTs.

5. Process for manufacturing a fibrous substrate according to claim 1, characterized in that the impregnaton comprises placing the fibrous substrate in a fluidized bed, in which the organic polymer or mixture of organic polymers containing carbon nanotubes is in powder form.

6. Process for manufacturing a fibrous substrate according to claim 5, characterized in that the impregnation comprises depositing the organic polymer containing carbon nanotubes or mixture of organic polymers containing carbon nanotubes directly onto the said assembly, placed flat on a support, and vibrating to distribute powder over the substrate.

7. Process for manufacturing a fibrous substrate according to claim 1, characterized in that the impregnation comprises extruding a flow of organic polymer containing carbon nanotubes or mixture of organic polymers containing carbon nanotubes onto the assembly that is in the form of a lap or strip or braid, by calendaring.

8. Fibrous substrate comprising an assembly of one or more fibres constituting felts or nonwovens in the form of strips, laps, braids, locks or pieces, preimpregnated with an organic polymer containing carbon nanotubes or a mixture of organic polymers containing carbon nanotubes, the carbon nanotubes comprising from 0.1% to 30% of the weight of the organic polymer or of the mixture of organic polymers.

9. Fibrous substrate comprising an assembly of one or more continuous fibres, or an assembly of short fibres, in the form of strips, laps, braids, locks or pieces, preimpregnated with an organic polymer carbon nanotubes or a mixture of organic polymers containing carbon nanotubes, obtained via the process according to claim 1.

10. Fibrous substrate according to claim 8, characterized in that the organic polymer is selected from the group consisting of thermoplastic polymers and thermosetting polymers.

11. Fibrous substrate according to claim 10, characterized in that the thermoplastic polymer is selected from the group consisting of:
polyamides selected from the group consisting of polyamide 6, polyamide 11, polyamide 12, polyamide 6/6, polyamide 4/6, polyamide 6.10 and polyamide 6/12, and copolymers, containing amide monomers;
aromatic polyamides;
fluoro polymers selected from the group consisting of:
(i) fluoro polymers comprising at least 50 mol % of at least one fluoro monomer of formula (I):
CFX₁═CX₂X₃ (I)
in which X₁, X₂ and X₃ independently denote a hydrogen or halogen atom (in particular a fluorine or chlorine atom),
(ii) fluoro polymers comprising at least 50 mol % of at least one monomer of formula (II):
R—O—CH═CH₂ (II)
in which R denotes a perhalogenated alkyl radical,
polyaryl ether ketones;
polyetherimides;
polyphenylene sulfides;
polyolefins optionally functionalized with an acid or anhydride group;
thermoplastic polyurethanes;
polyethylene terephthalates or polybutylene terephthalates;
polyvinyl chlorides;
polyalkyl (meth)acrylates comprising C1 to C8 alkyl;
poly(meth)acrylic acids;
polycarbonates;
silicone polymers;
phenoxy polymers;
and mixtures thereof.

12. Fibrous substrate according to claim 10, characterized in that the thermoplastic polymer is selected from the group consisting of: fluoro polymers or copolymers containing at least 50% of vinylidene fluoride, polyamides, copolyamides, polyaryl ethers, polyvinyl alcohols poly vinyl chlorides, polyetherimides and polyphenylene sulfides.

13. Fibrous substrate according to claim 10, characterized in that the thermosetting polymer is selected from the group consisting of: unsaturated polyesters, epoxy resins, vinyl esters, phenolic resins, polyurethanes, cyanoacrylates, polyimides, aminoplasts, and mixtures thereof.

14-22. (canceled)

23. Fibrous substrate according to claim 8, characterized in that the fibres are selected from the group consisting of carbon fibres, glass fibres, polymer-based fibres, plant fibres boron fibers, silica fibers and mixtures thereof.

24. Fibrous substrate according to claim 23, characterized in that the polymer based fibres are formed from polymers selected from the group consisting of:
(i) poly(vinyl alcohol),
(ii) polyamide selected from the group consisting of polyamide 6, polyamide 11, polyamide 12, polyamide 6/6, polyamide 4/6, polyamide 6/10, polyamide 6/12, and aromatic polyamides,
(iii) polyolefins selected from the group consisting of high-density polyethylene, polypropylene copolymers of ethylene and propylene,
(iv) polyester,
(v) polyaryl ether ketone (PAEK),
(vi) fluoro polymer, selected from the group consisting of:
(a) fluoro polymers comprising at least 50 mol % of at least one fluoro monomer of formula (I):
CFX₁═CX₂X₃ (I)
in which X₁, X₂ and X₃ independently denote a hydrogen or halogen atom;
(b) fluoropolymers comprising at least 50 mol % of at least one monomer of formula (II):
R—O—CH═CH₂ (II)
in which R denotes a perhalogenated alkyl radical,
(vii) thermoplastic polyurethane;
(viii) polyethylene terephthalates or polybutylene terephthalates;
(ix) polyvinyl chloride;
(x) phenoxy polymers;
(xi) unsaturated polyesters, epoxy resins, vinyl esters, phenolic resins, polyurethanes, cyanoacrylates, polyimides, aminoplasts, and mixtures thereof.

25. Fibrous substrate according to claim 8, characterized in that the carbon nanotubes are single-wall, double-wall or multi-wall nanotubes.

26. Fibrous substrate according to claim 9, characterized in that the carbon nanotubes represent from 0.1% to 30% of the weight of the organic polymer or of the mixture of organic polymers.

27-29. (canceled)
